(19) United States
(12) Patent Application Publication
(10) Pub. No.: US 2012/0150726 A1
(43) Pub. Date: Jun. 14, 2012

(54) PAYMENT SYSTEM USING SPENDING GATES

(75) Inventor: Frank Anthony Nuzzi, Pflugerville, TX (US)

(73) Assignee: EBAY, INC., San Jose, CA (US)

(21) Appl. No.: 12/966,212

(22) Filed: Dec. 13, 2010

(51) Int. Cl. G06Q 20/00

(52) U.S. Cl. 705/39

(57) ABSTRACT

A method for making a payment includes receiving a plurality of spending gate definitions for a customer account over a network. Each of the plurality of spending gate definitions associates at least one of a plurality of funding sources of the customer account with a purchase amount range. The plurality of spending gate definitions are stored in a database. A payment request for a purchase using the customer account is received over the network. The payment request includes a payment amount. The payment amount is corresponds to a first purchase amount range included in at least one of the spending definitions in the database. A payment is made using the at least one funding source of the customer account that is associated with the first purchase amount range according to the at least one spending definition.

### BACKGROUND

1. Field of the Invention

The present invention generally relates to online payments and more particularly to a payment system using spending gates.

2. Related Art

More and more consumers are purchasing items and services over electronic networks such as, for example, the Internet. Consumers routinely purchase products and services from merchants and individuals alike. The transactions may take place directly between an on-line merchant or retailer and the consumer, and payment is typically made by entering credit card or other financial information. Transactions may also take place with the aid of an on-line payment provider such as, for example, PayPal, Inc. of San Jose, Calif. Such payment providers can make transactions easier and safer for the parties involved. Purchasing with the assistance of an on-line payment provider from the convenience of virtually anywhere using a mobile device is one main reason why on-line purchases are growing very quickly.

Typically, the consumer will provide the on-line payment provider with a plurality of funding sources for use in making payments. For example, the consumer may provide one or more bank accounts and/or credit accounts to the on-line payment provider to be used to make payments for purchases made by the consumer. The bank account(s) and/or credit account(s) are conventionally prioritized such that, for example, a first bank account is given highest priority, a second bank account is given second highest priority, and a credit account is given third highest priority. When any purchase is then made by the consumer and paid for with the assistance of the on-line payment provider, the on-line payment provider will fund the payment with the first bank account unless the first bank account does not have sufficient funds to cover the purchase, the second bank account when the first bank account has insufficient funds unless the second bank account does not have sufficient funds to cover the purchase, and the credit account when the first bank account and the second bank account have insufficient funds. Once the funding source priority is set, payments for any purchases made using the customer account are funded entirely from one of the funding sources in the priority determined, based on available funds as discussed above, until the consumer instructs the on-line payment provider to reorder the priority. Thus, conventional on-online payment systems do not provide consumers with flexibility in regard to how funding sources are used to provide payments for different purchases.

Thus, there is a need for an improved on-line payment system.

### SUMMARY

According to one embodiment, a method for making a payment includes receiving a plurality of spending gate definitions for a customer account over a network, wherein each of the plurality of spending gate definitions associates at least one of a plurality of funding sources of the customer account with a purchase amount range, storing the plurality of spending gate definitions in a database, receiving a payment request for a purchase using the customer account over the network, wherein the payment request includes a payment amount, determining that the payment amount corresponds to a first purchase amount range included in at least one of the spending definitions in the database, and making a payment using the at least one funding source of the customer account that is associated with the first purchase amount range according to the at least one spending definition.

In an embodiment, the customer may set one or more spending gate definitions for their customer account for each of a plurality of purchase amount ranges. Subsequently, for each purchase made using the customer account, payment will be made for the purchase according to the spending gate definition(s) that include(s) the purchase amount range that the payment amount of that payment falls in. For example, the customer may set their spending gate definitions such that a checking account is used to make payments for relatively small cost purchases (e.g., purchases between 0 and 50 dollars), a credit account having a particular incentive program is used to make payments for relatively medium cost purchases (e.g., purchases between 50.01 and 250 dollars), and a credit account having the lowest interest rate of all the credit accounts associated with the customer account is used to make payments for relatively large cost purchases (e.g., purchases from 250.01 dollars and up.)

As a result, payments are automatically made for purchases using the customer account according to customizable and specific rules, which gives the customer flexibility in regard to how funding sources associated with the customer account are used to provide payments for different purchases.

These and other features and advantages of the present disclosure will be more readily apparent from the detailed description of the embodiments set forth below taken in conjunction with the accompanying figures.

### BRIEF DESCRIPTION OF THE FIGURES

FIG. 1a is a flow chart illustrating an embodiment of a method for making a payment;

FIG. 1b is a screenshot view illustrating an embodiment of a customer account website with an editable spending gate definition;

FIG. 1c is a screenshot view illustrating an embodiment of a customer account website with a spending gate definition;

FIG. 1d; is a screenshot view illustrating an embodiment of a customer account website with a plurality of spending gate definitions;

FIG. 1e is a screenshot view illustrating an embodiment of a customer account website with a plurality of editable conditions for a spending gate definition;

FIG. 1f is a screenshot view illustrating an embodiment of a customer account website with a plurality of spending gate definitions including spending gate conditions;

FIG. 1g is a screenshot view illustrating an embodiment of a customer account website with a plurality of editable conditions for a spending gate definition;

FIG. 1h is a screenshot view illustrating an embodiment of a customer account website with a plurality of spending gate definitions including spending gate conditions;

FIG. 1i is a screenshot view illustrating an embodiment of a customer account website with an editable gate splitter for a spending gate definition;

FIG. 1j is a screenshot view illustrating an embodiment of a customer account website with a plurality of spending gate definitions including gate splits;

FIG. 2 is a schematic view illustrating an embodiment of networked payment system;

FIG. 3 is a schematic view illustrating an embodiment of a computer system; and

FIG. 4 is a schematic view illustrating an embodiment of a payment service provider.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides a system and method for making a payment for a purchase made using a customer account according to a plurality of spending gate definitions associated with that customer account. Each of the plurality of spending gate definitions associate at least one of a plurality of funding sources of the customer account with a purchase amount range such that a plurality of purchase amount ranges are provided that each include a spending gate definition that defines which, when, and how funding sources are to be used to make a payment for a purchase that falls in that purchase amount range. This allows a customer to define different funding sources for different purchases and precisely control how purchases are paid for.

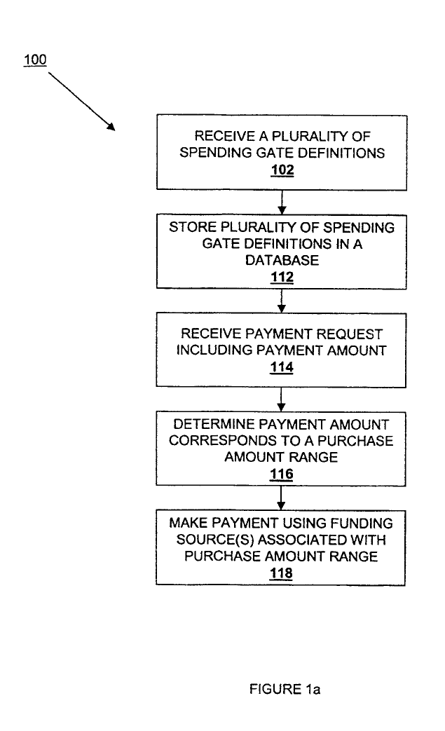

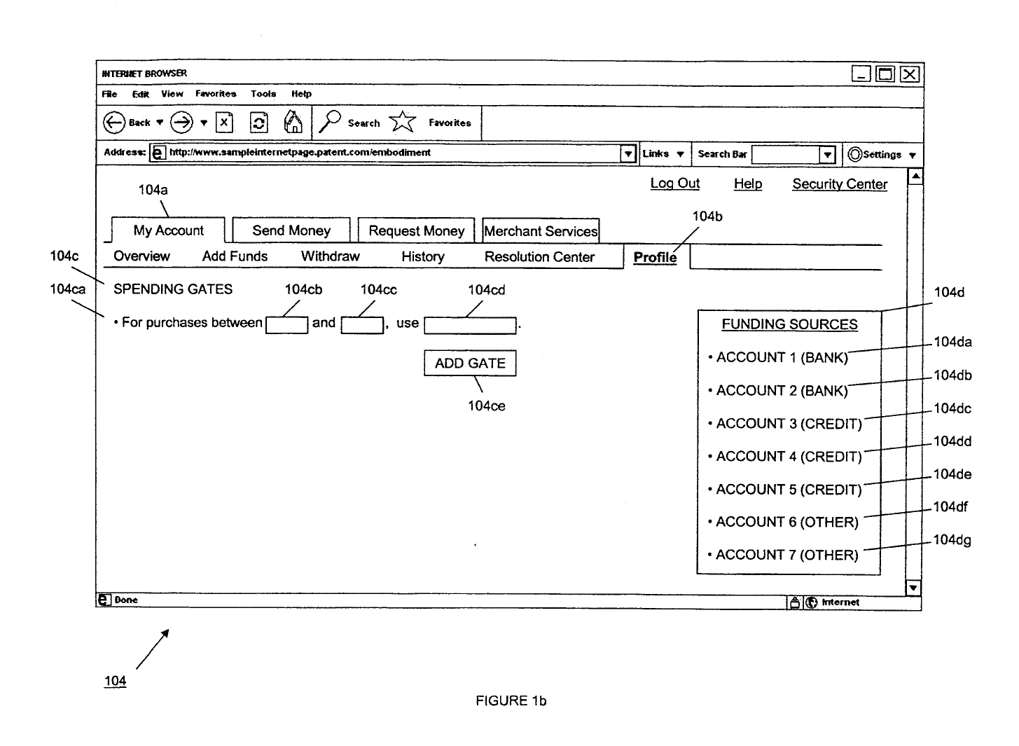

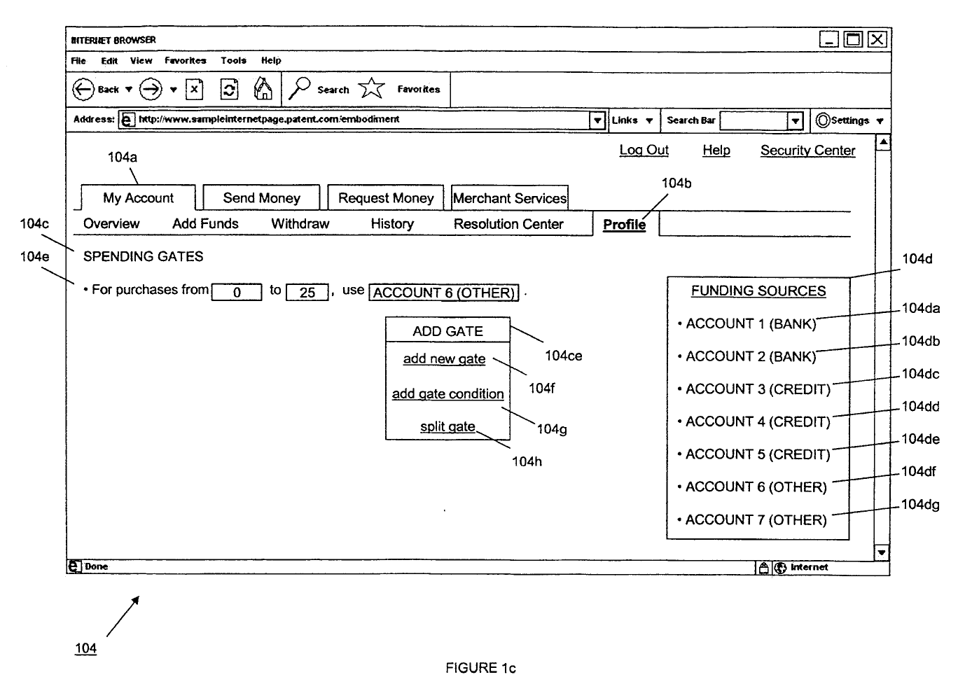

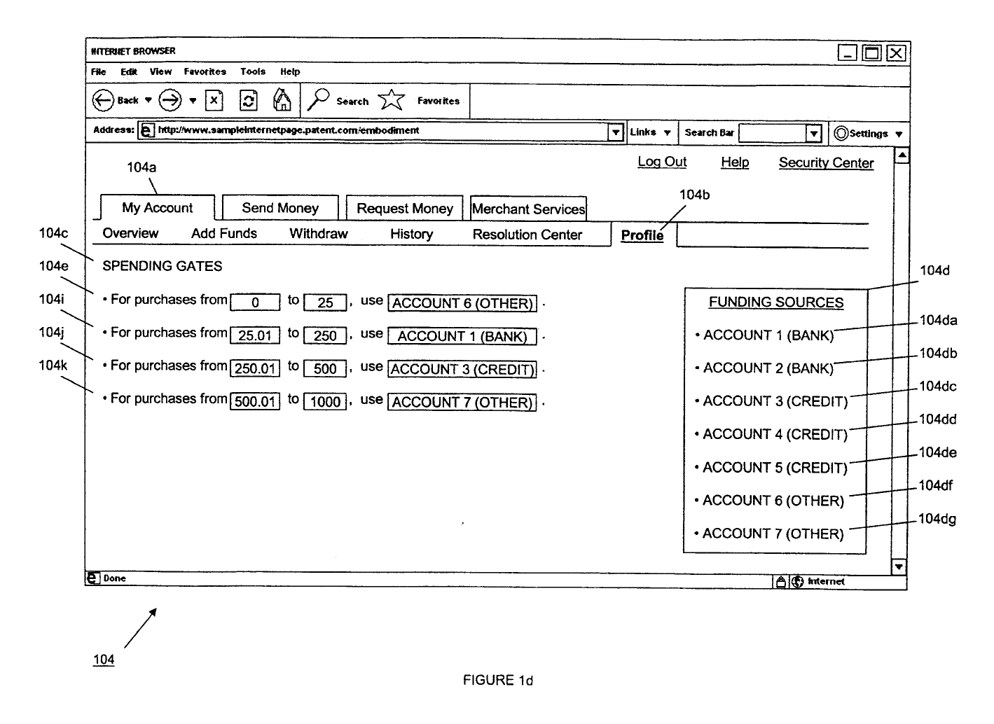

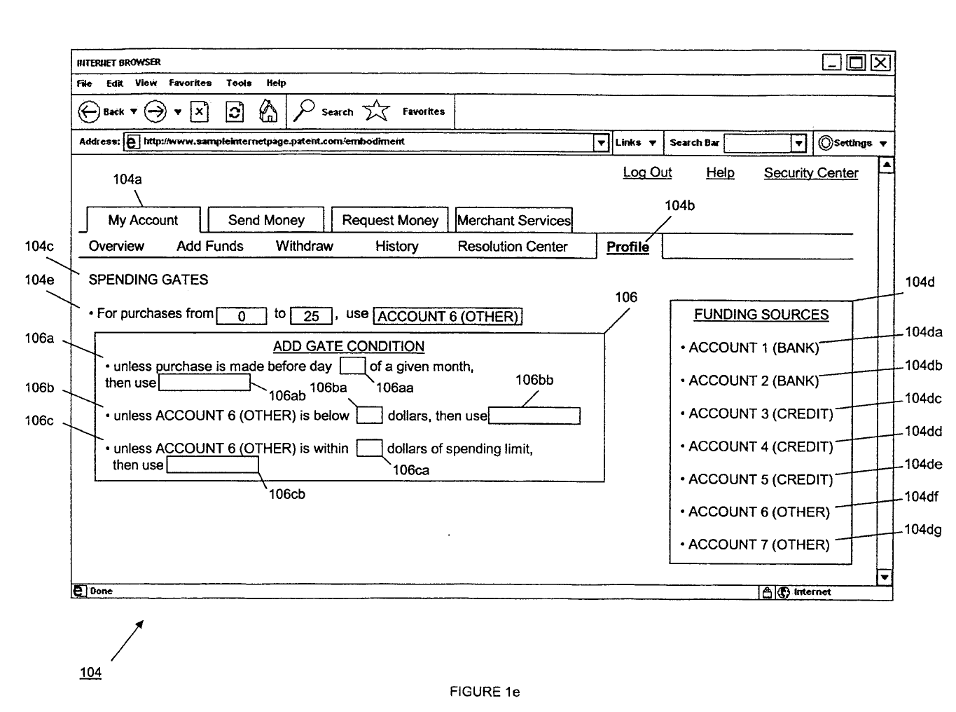

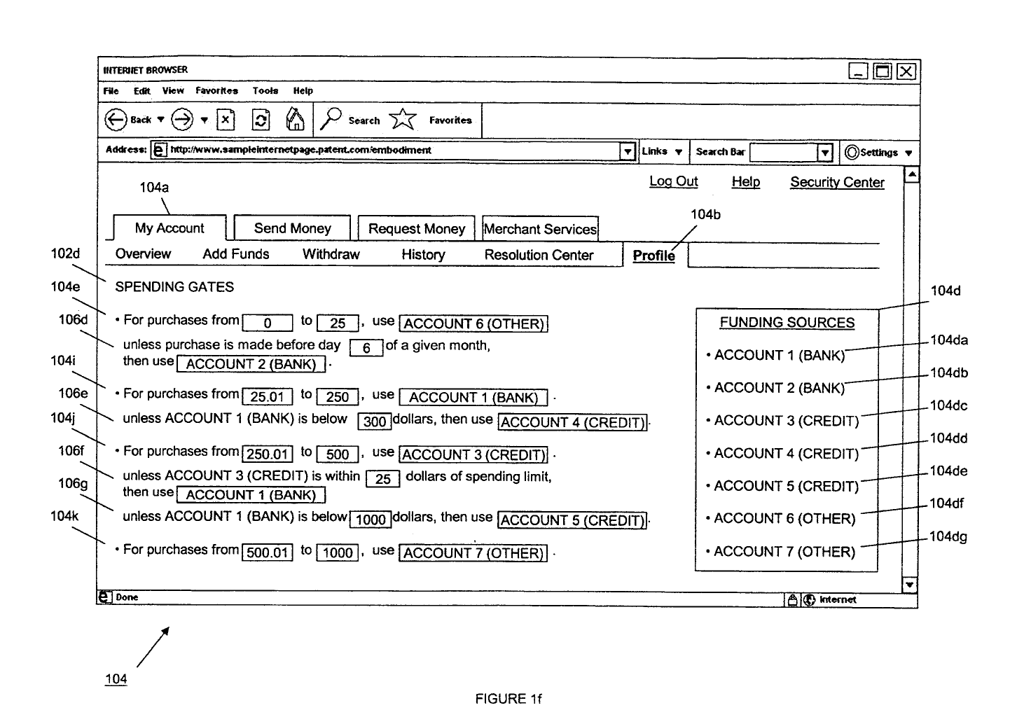

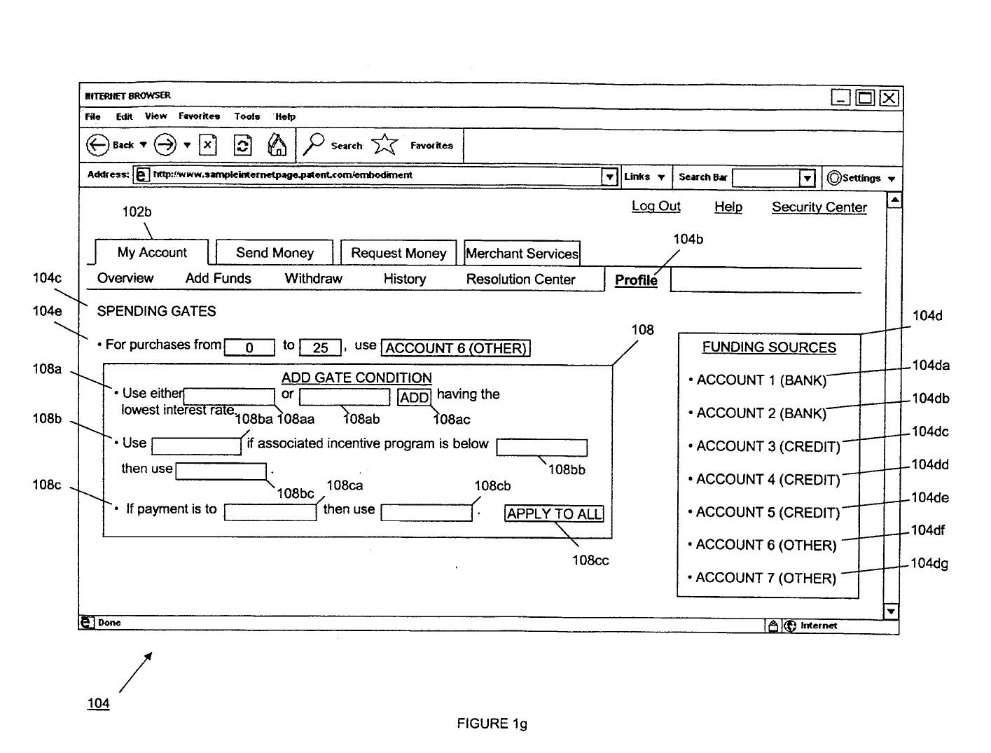

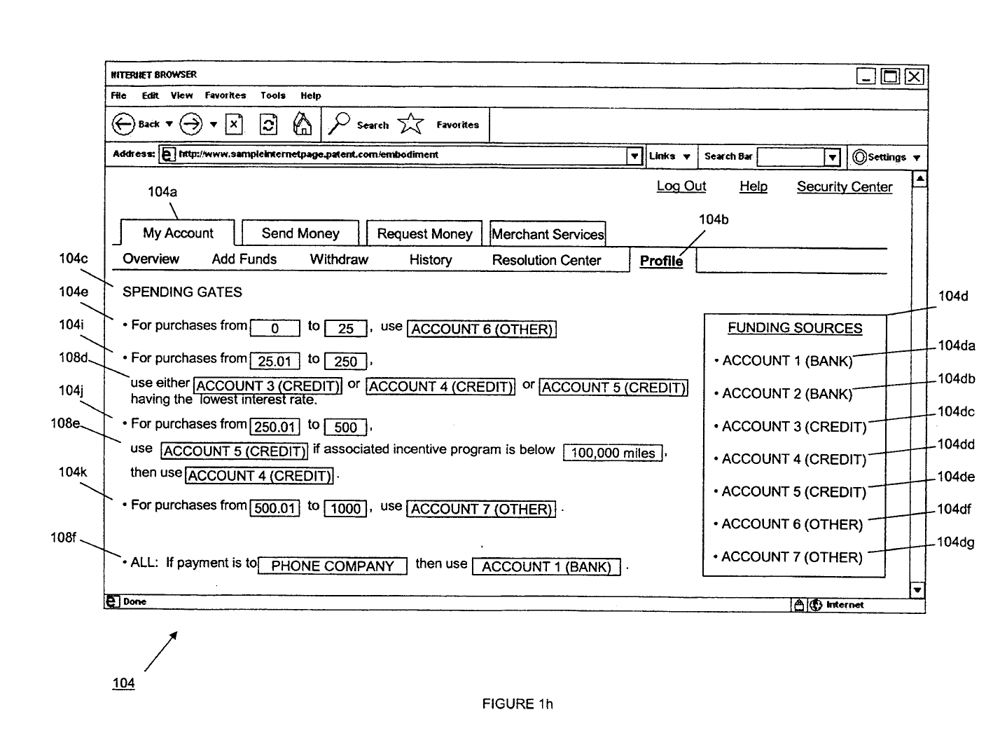

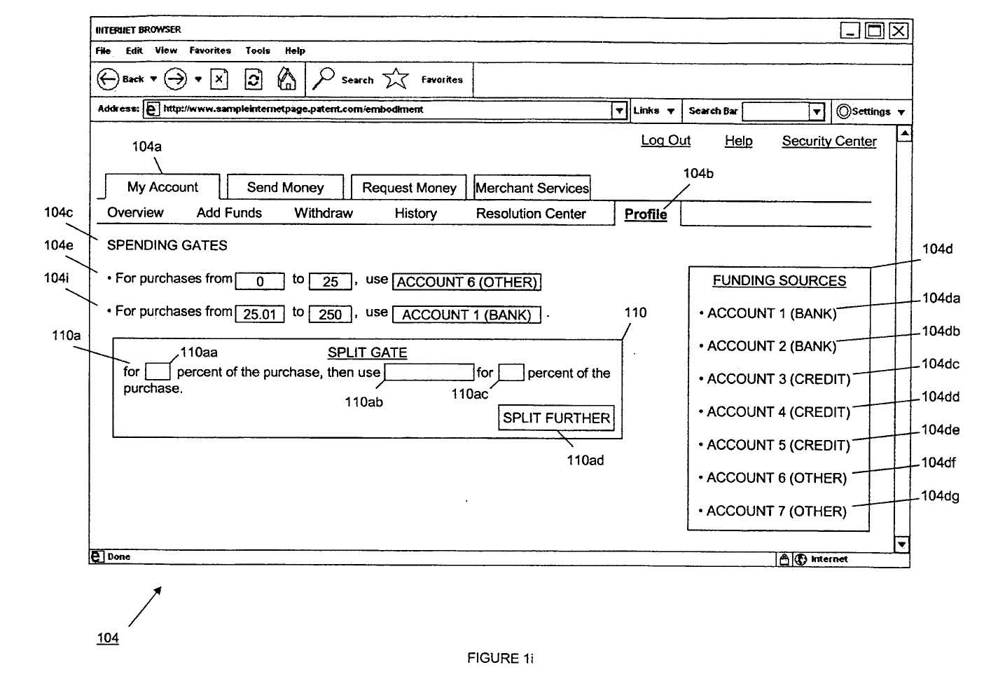

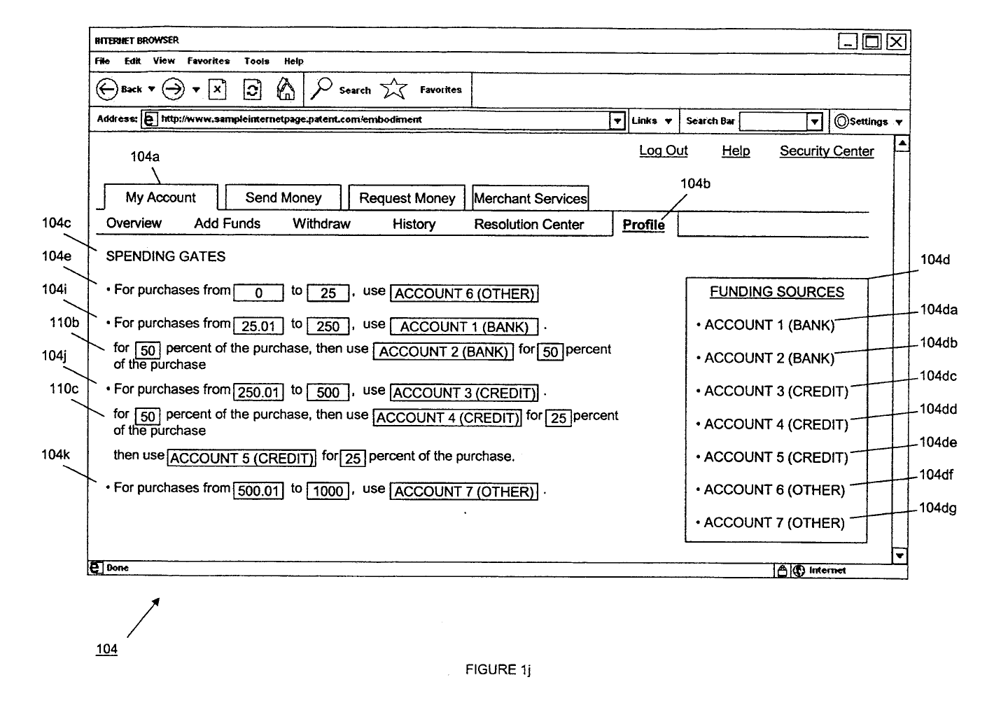

Referring now to FIGS. 1a, 1b, 1c, and 1d, a method 100 for making a payment is illustrated. The method 100 begins at block 102 where a payment service provider receives a plurality of spending gate definitions for a customer account. FIG. 1b illustrates an embodiment of a screenshot of a customer account website 104 that allows a customer to provide a plurality of spending definitions to a payment service provider. In an embodiment, the customer account website 104 may be provided by the payment service provider and accessed by the customer using networked computer systems, described in further detail below. One of skill in the art will recognize that the customer may provide a variety of information (e.g., a login ID, a password, etc.) to gain access to the customer account website 104 having one or more web pages as described below. The customer account website 104 includes a My Account tab 104a having a Profile section 104b. The Profile section 104b includes a Spending Gates definition section 104c and a Funding Sources section 104d. The Spending Gates definition section 104c includes an editable definition 104ca having a plurality of input fields 104cb, 104cc, and 104cd, and an Add Gate button 104ce. The Funding Sources section 104d includes a plurality of funding sources 104da, 104db, 104dc, 104dd, 104de, 104df, and 104dg. In an embodiment, the plurality of funding sources 104da, 104db, 104dc, 104dd, 104de, 104df, and 104dg include banking accounts, credit accounts, and other accounts of the customer to which the payment service provider has access in order to make payments.

The customer may use the customer account website 104 by filling in the plurality of input fields 104cb and 104cc of the editable definition 104ca with desired purchase amounts to create a purchase amount range (while the illustrated embodiment uses dollars for the purchase amounts, euros, yuan, and/or a variety of other currencies known in the art may be used without departing from the scope of the present disclosure) and filling in the input field 104cd with a funding source (e.g., one of the funding sources 104da, 104db, 104dc, 104dd, 104de, 104df, and 104dg), as illustrated in FIG. 1c. For example, in the embodiment illustrated in FIG. 1c, the customer has used the editable definition 104ca of FIG. 1b to create a spending gate definition 104e that instructs the payment service provider to use funding source 104df (ACCOUNT 6 (OTHER)) for any purchase up to $25.00. For example, the customer may desire that small purchases (e.g., a purchase amount range between $0 and $25.00) be paid for using credits from an account provided by the payment service provider (i.e., ACCOUNT 6 (OTHER)), and the spending gate definition 104e provides that instruction to the payment service provider. The customer may then select the Add Gate button 104ce in order to be presented with an Add New Gate link 104f, an Add Gate Condition link 104g, and a Split Gate link 104h, as illustrated in FIG. 1c.

The customer may select the Add New Gate link 104f in the Add Gate button 104ce of FIG. 1b to be presented with an editable definition that is substantially similar to the editable definition 104ca of FIG. 1b and the customer may then fill in the plurality of input fields (substantially similar to the input fields 104cb and 104cc of FIG. 1b) associated with each editable definition with desired purchase amounts to create purchase amount ranges and fill in the input fields (substantially similar to the input field 104cd of FIG. 1b) with funding sources to create one or more spending gate definitions. One of skill in the art will recognize that the customer may use the Add New Gate link 104f to create as many spending gate definitions as the customer desires.

For example, in the embodiment illustrated in FIG. 1d, the customer has used an editable definition to create a spending gate definition 104i that instructs the payment service provider to use funding source 104da (ACCOUNT 1 (BANK)) for any purchase between $25.01 and $250.00. For example, the customer may desire that smaller intermediate purchases (e.g., a purchase amount range between $25.01 and $250.00) be paid for using a bank account (i.e., ACCOUNT 1 (BANK)), and the spending gate definition 104i provides that instruction to the payment service provider. The customer has also used an editable definition to create a spending gate definition 104j that instructs the payment service provider to use funding source 104dc (ACCOUNT 3 (CREDIT)) for any purchase between $250.01 and $500.00. For example, the customer may desire that larger intermediate purchases (e.g., a purchase amount range between $250.01 and $500.00) be paid for using a credit account (i.e., ACCOUNT 3 (CREDIT)), and the spending gate definition 104j provides that instruction to the payment service provider. The customer has also used an editable definition to create a spending gate definition 104k that instructs the payment service provider to use funding source 104dg (ACCOUNT 7 (OTHER)) for any purchase between $500.01 and $1000.00. For example, the customer may desire that large purchases (between $500.01 and $1000.00) be paid for using an account provided by the payment service provider that bills the customer for the purchase at a later time (e.g., a BillMeLater account known in the art and provided by PayPal, Inc. of San Jose, Calif.) (i.e., ACCOUNT 7 (OTHER)), and the spending gate definition 104k provides that instruction to the payment service provider.

While a plurality of spending gate definitions 104e, 104i, 104j, and 104k have been illustrated and discussed, one of skill in the art will recognize that a plurality of other spending gate definitions may be created using the techniques described above without departing from the scope of the present disclosure (e.g., the spending maximum for a funding source may be unbounded for the largest purchases (e.g., purchases from “$500.01 and up” or “$500.01 to the limits of the funding source”). Furthermore, a variety of other spending gate definitions may be combined with the spending gate definitions 104e, 104i, 104j, and 104k, a few embodiments of which are discussed in further detail below.

Referring now to FIGS. 1e and 1f, the customer may select the Add Gate Condition link 104g in the Add Gate button 104ce of FIG. 1b subsequent to creating any spending gate definition (e.g., the spending gate definitions 104e, 104i, 104j, and 104k.) Selection of the Add Gate Condition link 104g presents the customer with an Add Gate Condition box 106 that includes a plurality of editable conditions 106a, 106b and 106c, as illustrated in FIG. 1e. The editable condition 106a includes a plurality of input fields 106aa and 106ab, the editable condition 106b includes a plurality of input fields 106ba and 106bb, and the editable condition 106c includes a plurality of input fields 106ca and 106cb.

The customer may use the customer account website 104 by selecting one of the editable conditions 106a, 106b, or 106c and filling in the plurality of input fields associated with that editable condition with the appropriate information (e.g., a day of the month for input field 106aa associated with editable condition 106a, a dollar amount for inputs fields 106ba and 106ca associated with editable conditions 106b and 106c, and funding source(s) for input fields 106ab, 106bb, and 106cb.)

For example, in the embodiment illustrated in FIG. 1f, the customer has used the editable condition 106a of FIG. 1e to add a spending gate condition 106d to the spending gate definition 104e that instructs the payment service provider to use funding source 104db (ACCOUNT 2 (BANK)) for any purchase up to $25.00 if the purchase is made before the 6^{th} day of a given month, and at other times to use the funding source 104df (ACCOUNT 6 (OTHER)). For example, the customer may desire that small purchases (e.g., a purchase amount range between $0 and $25.00) be paid for using credits from an account provided by the payment service provider (i.e., ACCOUNT 6 (OTHER)) unless it is before the 6^{th} day of a given month and, if it is, to use the funding source 104db (ACCOUNT 2 (BANK)) due to, for example, that funding source having a deposit that is regularly deposited at the beginning of the month, and the spending gate condition 106d modifies the spending gate definition 104e to provide that instruction to the payment service provider.

The customer has also used the editable condition 106b of FIG. 1e to add a spending gate condition 106e to the spending gate definition 104i that instructs the payment service provider to use funding source 104dd (ACCOUNT 4 (CREDIT)) for any between $25.01 and $250.00 if funding source 104da (ACCOUNT 1 (BANK)) is below $300. For example, the customer may desire that smaller intermediate purchases (e.g., a purchase amount range between $25.01 and $250.00) be paid for using a bank account (i.e., ACCOUNT 1 (BANK)) unless the balance in that bank account is below $300 and, if it is, to use the funding source 104dd (ACCOUNT 4 (CREDIT)) in order to ensure that the balance on the bank account does not get too low, and the spending gate condition 106e modifies the spending gate definition 104i to provide that instruction to the payment service provider.

The customer has also used editable conditions 106c and 106b of FIG. 1e to create a spending gate definition 104j that instructs the payment service provider to use funding source 104da (ACCOUNT 1 (BANK)) for any purchase between $250.01 and $500.00 if the funding source 104dc (ACCOUNT 3 (CREDIT)) is within $25 of a spending limit, and to use funding source 104de (ACCOUNT 5 (CREDIT)) for any purchase between $250.01 and $500.00 if the funding source 104dc (ACCOUNT 1 (BANK)) is within $25 of a spending limit and the funding source 104dc (ACCOUNT 3 (CREDIT)) is below $1000 dollars. For example, the customer may desire that larger intermediate purchases (e.g., a purchase amount range between $250.01 and $500.00) be paid for using a credit account (i.e., ACCOUNT 3 (CREDIT)) unless the credit account is close to its spending limit and, if it is, to use a bank account (ACCOUNT 1 (BANK)) but, if the bank account it below $1000, then to use another credit account (ACCOUNT 5 (CREDIT)) that may not be used often and can handle a large single purchase, and the spending gate conditions 106f and 106g modify the spending gate definition 104j to provide that instruction to the payment service provider.

Referring now to FIGS. 1g and 1h, in another embodiment, the customer may select the Add Gate Condition link 104g in the Add Gate button 104ce of FIG. 1b subsequent to creating any spending gate definition (e.g., the spending gate definitions 104e, 104i, 104j, and 104k.) Selection of the Add Gate Condition link 104g presents the customer with an Add Gate Condition box 108 that includes a plurality of editable conditions 108a, 108b and 108c, as illustrated in FIG. 1g. The editable condition 108a includes a plurality of input fields 108aa and 108ab along with an Add button 108ac, the editable condition 108b includes a plurality of input fields 108ba, 108bb, and 108bc, and the editable condition 108c includes a plurality of input fields 108ca and 108cb along with an Apply To All button 108cc.

The customer may use the customer account website 104 by selecting one of the editable conditions 108a, 108b, or 108c and filling in the plurality of input fields associated with that editable condition with the appropriate information and using the buttons when necessary (e.g., selecting a funding source for input fields 108aa, 108ab, 108ba, 108bc, and 108cb, inputting an incentive program level in input field 108bb, inputting a payee in input field 108ca, selecting the Add button 108ac to add a funding source input field to editable condition 108a, and selecting the Apply To All button 108cc to apply the editable condition 108c to all the spending definitions.)

For example, in the embodiment illustrated in FIG. 1h, the customer has used the editable condition 108a of FIG. 1g to add a spending gate condition 108d to the spending gate definition 104i that instructs the payment service provider to use a funding source, selected from funding sources 104dc (ACCOUNT 3 (CREDIT)), 104dd (ACCOUNT 4 (CREDIT)), and 104de (ACCOUNT 5 (CREDIT)), that has the lowest interest rate for any purchase between $25.01 to $250.00. One of skill in the art will recognize that the customer has selected the Add button 108ac of editable condition 108a to include the three funding sources 104dc, 104dd, and 104de in the spending gate condition 108d and that the customer may do the same to add as many funding sources to similar spending gate conditions as is desired. For example, the customer may desire that smaller intermediate purchases (e.g., a purchase amount range between $25.01 and $250.00) be paid for using the credit account of the customer that has the lowest interest rate, and the spending gate condition 108d modifies the spending gate definition 104i to provide that instruction to the payment service provider.

The customer has also used editable condition 108b of FIG. 1g to create a spending gate definition 104j that instructs the payment service provider to use funding source 104de (ACCOUNT 5 (CREDIT)) for any purchase between $250.01 and $500.00 if an incentive program associated with that funding source is below 100,000 miles, and if the incentive program is not below 100,000 miles, then to use funding source 104dd (ACCOUNT 4 (CREDIT)). For example, the customer may desire that larger intermediate purchases (e.g., a purchase amount range between $250.01 and $500.00) be paid for using a credit account (i.e., ACCOUNT 5 (CREDIT)) until an incentive associated with that credit account (in the illustrated embodiment, airline miles) is achieved, and then once that incentive is achieved, to use a credit account (ACCOUNT 4 (CREDIT)) that may have a different incentive program that the customer then wishes to receive an incentive from, and the spending gate conditions 108e modifies the spending gate definition 104j to provide that instruction to the payment service provider.

The customer has also used editable condition 108c of FIG. 1g to create a spending gate condition 108f that instructs the payment service provider to use funding source 104da (ACCOUNT 1 (BANK)) for any purchase from a specific payee (in the illustrated embodiment, PHONE COMPANY.) One of skill in the art will recognize that the customer has selected the Apply To All button 108c to apply the spending gate condition to all spending gate definitions, and that similar spending gate conditions may be applied to only one or some spending gate definitions. For example, the customer may desire that any bill from a specific payee (PHONE COMPANY) be paid for with a specific funding source (ACCOUNT 1 (BANK)) regardless of the payment amount, and the spending gate condition 108f modifies all the spending gate definitions 104e, 104i, 104j, and 104k to provide that instruction to the payment service provider.

While a plurality of spending gate conditions 106d, 106e, 106f, 106g, 108d, 108e, and 108f have been illustrated and discussed, one of skill in the art will recognize that a plurality of other spending gate conditions may be created using the techniques described above without departing from the scope of the present disclosure. Furthermore, the spending gate conditions may be used alone and/or with spending gate definitions without departing from the scope of the present disclosure.

Referring now to FIGS. 1i and 1j, the customer may select the Split Gate link 104h in the Add Gate button 104ce of FIG. 1b subsequent to creating any spending gate definition (e.g., the spending gate definitions 104e, 104i, 104j, and 104k.) Selection of the Split Gate link 104h presents the customer with a Split Gate box 110 that includes an editable gate splitter 110a, as illustrated in FIG. 1i. The editable gate splitter 110a includes a plurality of input fields 110aa, 110ab, and 110ac along with a Split Further button 110ad.

The customer may use the customer account website 104 by selecting the editable gate splitter 110a and filling in the plurality of input fields associated with that editable condition with the appropriate information and using the buttons when necessary (e.g., selecting a funding source for input field 110ab, inputting a percentage in input fields 110aa and 110ac, and selecting the Split Further button 110ad to add more input fields for splitting a spending definition purchase between additional funding sources.)

For example, in the embodiment illustrated in FIG. 1j, the customer has used the editable gate splitter 110a of FIG. 1i to add a gate splitter 110b to the spending gate definition 104ie that instructs the payment service provider to use funding source 104da (ACCOUNT 1 (BANK)) for 50% any purchase between $25.01 and $250.00 and to use funding source 104db (ACCOUNT 2 (BANK)) for the other 50% of that purchase. For example, the customer may desire that payments for smaller intermediate purchases (e.g., a purchase amount range between $25.01 and $250.00) be split evenly between funding sources (ACCOUNT 1 (BANK)) and (ACCOUNT 2 (BANK)), and the gate splitter 110b modifies the spending gate definition 104i to provide that instruction to the payment service provider.

The customer has also used editable gate splitter 110a of FIG. 1i to add a gate splitter 110b to the spending gate definition 104j that instructs the payment service provider to use funding source 104dc (ACCOUNT 3 (CREDIT)) for 50% any purchase between $250.01 and $500.00, to use funding source 104dd (ACCOUNT 4 (CREDIT)) for 25% of that purchase, and to use funding source 104de (ACCOUNT 5 (CREDIT)) for 25% of that purchase. One of skill in the art will recognize that the customer has selected the Split Further button 110ad to include the three funding sources 104dc, 104dd, and 104de at specific percentages for payments, and that the customer may do the same to split payments between any number of funding sources at any percentages desired. For example, the customer may desire that payments for larger intermediate purchases (e.g., a purchase amount range between $250.01 and $500.00) be split between funding sources (ACCOUNT 3 (CREDIT), ACCOUNT 4 (CREDIT), and ACCOUNT 5 (CREDIT)) in specific percentages, and the gate splitter 110c modifies the spending gate definition 104j to provide that instruction to the payment service provider.

While a plurality of gate splitters 110b and 110c have been illustrated and discussed, one of skill in the art will recognize that a plurality of other gate splits may be created using the techniques described above without departing from the scope of the present disclosure. Furthermore, the gate splitters may be used alone and/or with the spending gate conditions and/or spending gate definitions without departing from the scope of the present disclosure.

Referring back to FIG. 1a, the method 100 then proceeds to block 112 where the plurality of spending gate definitions are stored in a database. The payments service provider may take all the spending gate definitions (including spending gate conditions, gate splitters, etc.) and store those in a customer database. In an embodiment, the spending gate definitions are associated with the customer account that they were created for. The method 100 then proceeds to block 114 where a payment request including a payment amount is received. Subsequent to the creation of the plurality of spending gates, the customer may make a purchase using their customer account, and in response, a payment request for that purchase that includes a payment amount for the purchase is sent to the payment service provider. For example, a payment amount of $100 for a purchase made using the customer account may be received.

The method 100 then proceeds to block 116 where it is determined that the payment amount corresponds to a purchase amount range. The payment service provider may use information from the customer account along with the payment amount to access the spending gate definitions in the database and determine that the payment amount corresponds to a purchase amount range included in one of the spending definitions. In the example where the payment amount received is $100, the payment service provider may access the database and determine that the $100 payment amount corresponds to the purchase amount range of $25.01 to $250.00. The method 100 then proceeds to block 118 where payment is made using one or more funding sources associated with the purchase amount range determined in block 116.

In the example where the payment amount received is $100 and the purchase amount range is $25.01 to $250.00, the payment service provider may access the spending definition 104i illustrated in FIG. 1d and use the funding source 104da (ACCOUNT 1 (BANK)) to make the payment. In another embodiment, the payment service provider may access the spending definition 104i illustrated in FIG. 1f and use the funding source 104da (ACCOUNT 1 (BANK)) to make the payment unless the funding source 104da is below $300, and if the funding source 104da is below $300, then use the funding source 104dd (ACCOUNT 4 (CREDIT) to make the payment. In another embodiment, the payment service provider may access the spending definition 104i illustrated in FIG. 1h and use the funding source, selected from the funding sources 104dc (ACCOUNT 3 (CREDIT)), 104dd (ACCOUNT 4 (CREDIT)), or 104de (ACCOUNT 5 (CREDIT)), that has the lowest interest rate to make the payment. In an embodiment, the payment service provider may have account balance information or interest rate information for the funding sources in a database, or may retrieve the account balance information or interest rate information for the funding sources over a network. In another embodiment, the payment service provider may access the spending definition 104i illustrated in FIG. 1j and use the funding source 104da (ACCOUNT 1 (BANK)) to make the 50% of the payment and funding source 104db (ACCOUNT 2 (BANK)) to make the other 50% of the payment.

Thus, a system and method are described that allow a customer to define different funding sources for different purchases and precisely control how purchases are paid for. While a plurality of examples have been discussed above, one of skill in the art will recognize that the present disclosure is not so limited, and a variety of other embodiments will fall within its scope. As discussed above with respect to the spending gate definition that selects a funding source with the lowest interest rate or determines a funding source balance, the payment service provider may keep funding source information for funding sources in a database, or may retrieve such information over a network when needed. Other funding source information may include funding source spending limits, incentive program points/miles/etc., and a variety of other funding source information known in the art.

While the embodiment of the method above is directed to making a payment using a plurality of spending gates, the gates are not so limited and may instead be referred to as transaction gates that may define how a variety of transactions are dealt with by the payment service provider. For example, a transaction gate may define different funding sources for refunds, and when a refund is to be refunded to a customer (e.g., by a payee or the payment provider,) it will be drawn from an account determined using transaction gates that are substantially similar to the spending gates described above. In another example, a transaction gate may defined how a payment or credit should be received by defining different accounts for different payments or credits, and when a payment or credit is received, it will be deposited into an account determined using transaction gates that are substantially similar to the spending gates described above. One of skill in the art will recognize how a variety of transactions and transaction gates may be substituted for the spending gates in the embodiment of the method described above without departing from the scope of the present disclosure.

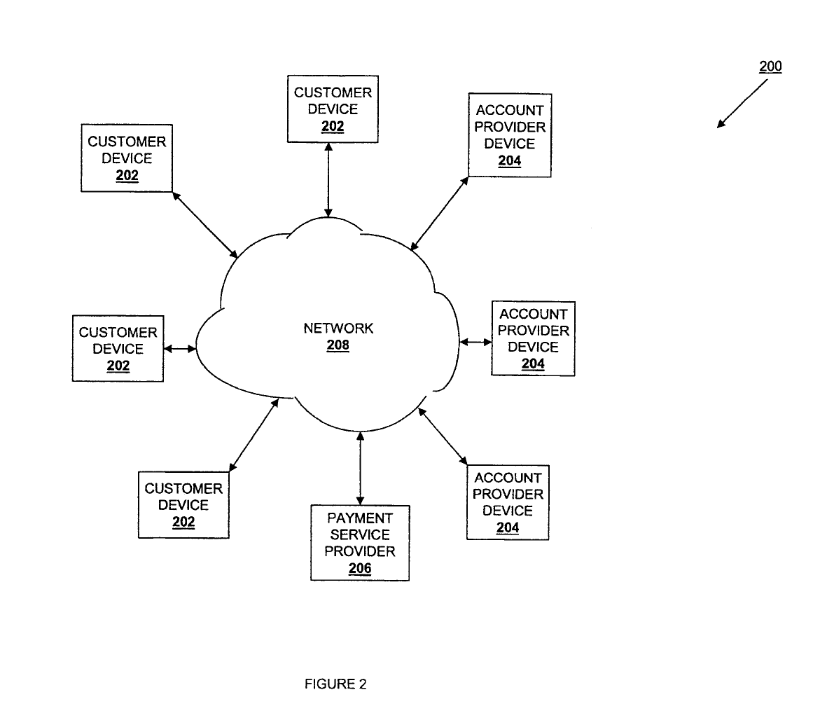

Referring now to FIG. 2, an embodiment of a networked system 200 used in the payment system is illustrated. The networked system 200 includes a plurality of customer devices 202, a plurality of account provider devices 204, and a payment service provider 206 in communication over a network 208. The customer devices 202 may be any device used to access the customer account website 104 and/or instruct the payment service provider 206 to make a payment, discussed above. The account provider devices 204 may be any device used to receive a payment from the payment service provider 206. The payment service provider 206 may include devices to provide the customer account website 104, discussed above, make a payment to a payee of the customer, or access an account provider to be reimbursed for a payment made, and may be a payment service provider such as, for example, PayPal Inc. of San Jose, Calif.

The customer devices 202, a account provider devices 204, and a payment service provider 206 (discussed in further detail below) may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 200, and/or accessible over the network 208.

The network 208 may be implemented as a single network or a combination of multiple networks. For example, in various embodiments, the network 208 may include the Internet and/or one or more intranets, landline networks, wireless networks, and/or other appropriate types of networks.

The customer devices 202 may be implemented using any appropriate combination of hardware and/or software configured for wired and/or wireless communication over network 208. For example, in one embodiment, the customer devices 202 may be implemented as a personal computer of a customer in communication with the Internet. In other embodiments, the customer devices 202 may be a smart phone, personal digital assistant (PDA), laptop computer, and/or other types of computing devices.

The customer devices 202 may include one or more browser applications which may be used, for example, to provide a convenient interface to permit the customer to browse information available over the network 208. For example, in one embodiment, the browser application may be implemented as a web browser configured to view information available over the Internet.

The customer devices 202 may also include one or more toolbar applications which may be used, for example, to provide payer-side processing for performing desired tasks in response to operations selected by the payer. In one embodiment, the toolbar application may display a user interface in connection with the browser application.

The customer devices 202 may further include other applications as may be desired in particular embodiments to provide desired features to the customer devices 202. In particular, the other applications may include a payment application for payments through the payment service provider 206. The other applications may also include security applications for implementing user-side security features, programmatic user applications for interfacing with appropriate application programming interfaces (APIs) over the network 208, or other types of applications. Email and/or text applications may also be included, which allow the customer to send and receive emails and/or text messages through the network 208. The customer devices 202 includes one or more user and/or device identifiers which may be implemented, for example, as operating system registry entries, cookies associated with the browser application, identifiers associated with hardware of the customer devices 202, or other appropriate identifiers, such as a phone number. In one embodiment, the user identifier may be used by the payment service provider 206 to associate the customer with a particular account maintained by the payment service provider 206 as further described herein.

The account provider device 204 may be maintained, for example, by an account provider that provides one or more of the funding sources for the customer account, discussed above. In this regard, the account provider device 204 may include a database identifying funding sources and respective funding source information for the customer account.

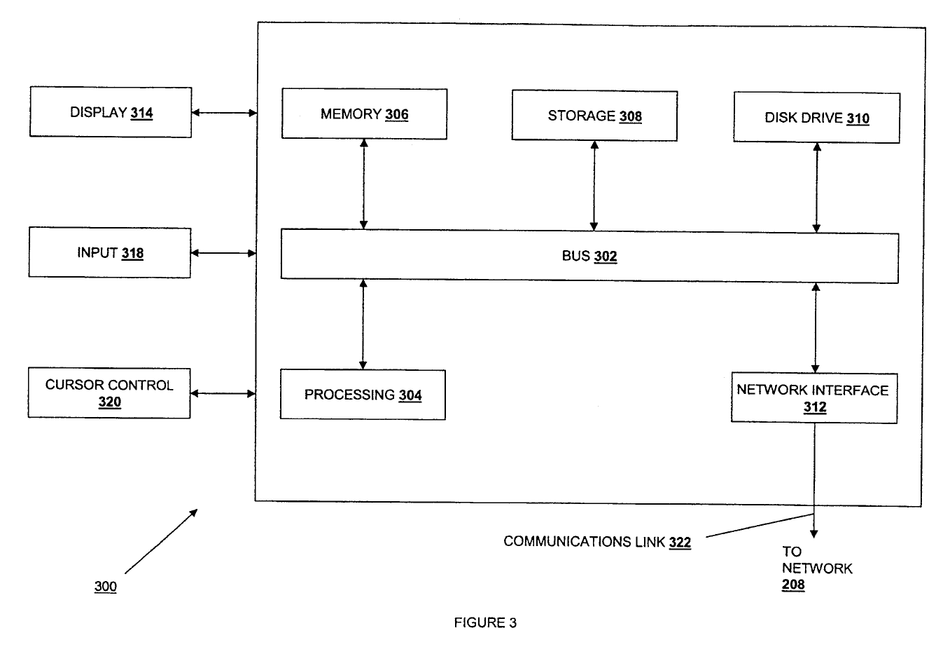

Referring now to FIGS. 2 and 3, an embodiment of a computer system 300 suitable for implementing, for example, the customer devices 202, the account provider devices 204, and/or devices associated with the payment service provider 206, is illustrated. In various implementations, the device(s) may comprise a computing device (e.g., a computer, laptop, smart phone, PDA, etc.) capable of communicating with the network 208. It should be appreciated that other devices utilized by customers, account providers, and payment service providers in the payment system may be implemented as the computer system 300 in a manner as follows.

In accordance with various embodiments of the present disclosure, computer system 300, such as a computer and/or a network server, includes a bus 302 or other communication mechanism for communicating information, which interconnects subsystems and components, such as a processing component 304 (e.g., processor, micro-controller, digital signal processor (DSP), etc.), a system memory component 306 (e.g., RAM), a static storage component 308 (e.g., ROM), a disk drive component 310 (e.g., magnetic or optical), a network interface component 312 (e.g., modem or Ethernet card), a display component 314 (e.g., CRT or LCD), an input component 318 (e.g., keyboard, keypad, or virtual keyboard), and/or a cursor control component 320 (e.g., mouse, pointer, or trackball). In one implementation, the disk drive component 310 may comprise a database having one or more disk drive components.

In accordance with embodiments of the present disclosure, the computer system 300 performs specific operations by the processor 304 executing one or more sequences of instructions contained in system the memory component 306, such as described herein with respect to customer devices 202, the account provider devices 204, and/or devices associated with the payment service provider 206. Such instructions may be read into the system memory component 306 from another computer readable medium, such as the static storage component 308 or the disk drive component 310. In other embodiments, hard-wired circuitry may be used in place of or in combination with software instructions to implement the present disclosure.

Logic may be encoded in a computer readable medium, which may refer to any medium that participates in providing instructions to the processor 304 for execution. Such a medium may take many forms, including but not limited to, non-volatile media, volatile media, and transmission media. In various implementations, non-volatile media includes optical or magnetic disks, such as the disk drive component 310, volatile media includes dynamic memory, such as the system memory component 306, and transmission media includes coaxial cables, copper wire, and fiber optics, including wires that comprise the bus 302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by the computer system 300. In various other embodiments of the present disclosure, a plurality of the computer systems 300 coupled by a communication link 322 to the network 208 (e.g., such as a LAN, WLAN, PTSN, and/or various other wired or wireless networks, including telecommunications, mobile, and cellular phone networks) may perform instruction sequences to practice the present disclosure in coordination with one another.

The computer system 300 may transmit and receive messages, data, information and instructions, including one or more programs (i.e., application code) through the communication link 322 and the network interface component 312. The network interface component 312 may include an antenna, either separate or integrated, to enable transmission and reception via the communication link 322. Received program code may be executed by processor 304 as received and/or stored in disk drive component 310 or some other non-volatile storage component for execution.

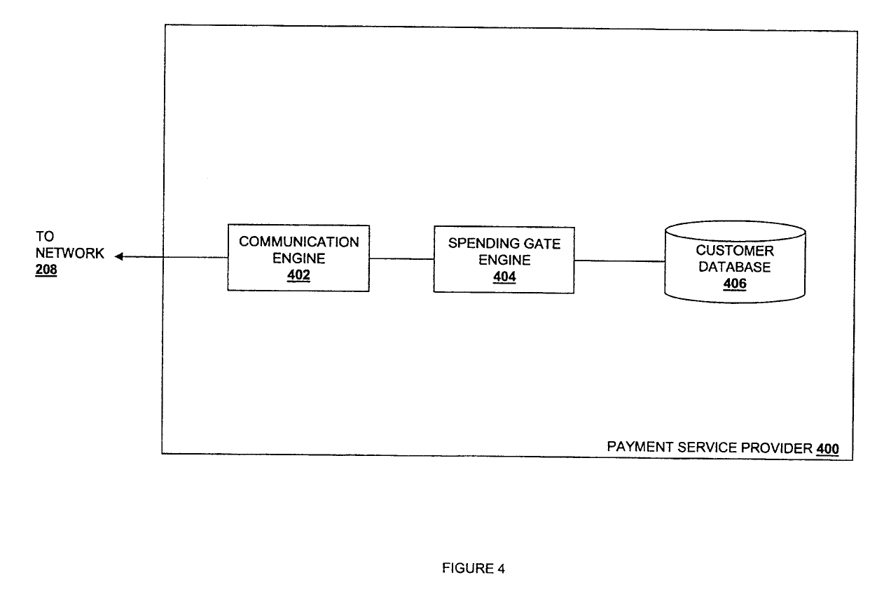

Referring now to FIGS. 2 and 4, an embodiment the payment service provider 400, which may be the payment service provider 206, is illustrated. The payment service provider 400 includes a communication engine 602 that is coupled to the network 208 and a spending gate engine 404. The spending gate engine 404 is coupled to the customer database 406. The communication engine 402 may be software or instructions stored on a computer-readable medium that allows the payment service provider to send and receive information over the network 208. The spending gate engine 404 may be software or instructions stored on a computer-readable medium that is operable to send and receive information to and from the communication engine 402 (e.g., payment requests, funding source information, etc.) and access the customer database 406 to retrieve spending gate definitions, as discussed above.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and seller; however, a user or consumer can pay virtually, or otherwise interact with any type of recipient, including charities and individuals. The payment does not have to involve a purchase, but can be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

1. A method for making a payment, comprising:
receiving a plurality of spending gate definitions for a customer account over a network, wherein each of the plurality of spending gate definitions associates at least one of a plurality of funding sources of the customer account with a purchase amount range;
storing the plurality of spending gate definitions in a database; and
receiving a payment request for a purchase using the customer account over the network, wherein the payment request includes a payment amount;
wherein in response to determining that the payment amount corresponds to a first purchase amount range included in at least one of the spending definitions in the database a payment is made using a funding source of the customer account that is associated with the first purchase amount range according to the at least one spending definition; and
wherein in response to determining that the payment amount corresponds to a second purchase amount range included in at least one of the spending definitions in the database, a payment is made using a funding source of the customer account that is associated with the second purchase amount range according to the at least one spending definition and that is different from the funding source of the customer account that is associated with the first purchase amount range.

2. The method of claim 1, wherein at least one of the plurality of spending gate definitions associates a first funding source with the first purchase amount range and a second funding source with the first purchase amount range and a date range, and wherein the payment is made using the first funding source if a current date is outside the date range and the payment is made using the second funding source if the current date is within the date range.

3. The method of claim 1, wherein at least one of the plurality of spending gate definitions associates a first funding source with the first purchase amount range and a minimum balance and a second funding source with the first purchase amount range, and wherein the payment is made using the first funding source if a current balance is above the minimum balance and the payment is made using the second funding source if the current balance is below the minimum balance.

4. The method of claim 1, wherein at least one of the plurality of spending gate definitions associates a first funding source with the first purchase amount range and a maximum balance and a second funding source with the first purchase amount range, and wherein the payment is made using the first funding source if a current balance is below the maximum balance and the payment is made using the second funding source if the current balance is above the maximum balance.

5. The method of claim 1, wherein at least one of the plurality of spending gate definitions associates a plurality of the funding sources with the first purchase amount range and a interest rate condition, and the method further comprises:
determining that a first funding source of the plurality of funding sources that are associated with the first purchase amount range complies with the interest rate condition; and
making the payment using the first funding source in response to the first funding source complying with the interest rate condition.

6. The method of claim 1, wherein at least one of the plurality of spending gate definitions associates a plurality of the funding sources with the first purchase amount range and incentive program condition, and the method further comprises:
determining that a first funding source of the plurality of funding sources that are associated with the first purchase amount range complies with the incentive program condition; and
making the payment using the first funding source in response to the first funding source complying with the incentive program condition.

7. The method of claim 1, wherein at least one of the plurality of spending gate definitions associates a first funding source with the first purchase amount range and a second funding source with the first purchase amount range and a payee, and wherein the payment is made using the first funding source if the payment request is not associated with the payee and the payment is made using the second funding source if the payment request is associated with the payee.

8. The method of claim 1, wherein at least one of the plurality of spending gate definitions associates each of a plurality of the funding sources with the first purchase amount range and a respective payment percentage, and wherein the payment is made using each of the plurality of funding sources associated with the first purchase amount range according to the respective payment percentage.

9. A machine-readable medium comprising a plurality of machine-readable instructions which, when executed by one or more processors, are adapted to cause the one or more processors to perform a method comprising:
receiving a plurality of spending gate definitions for a customer account over a network, wherein each of the plurality of spending gate definitions associates at least one of a plurality of funding sources of the customer account with a purchase amount range;
storing the plurality of spending gate definitions in a database; and
receiving a payment request for a purchase using the customer account over the network, wherein the payment request includes a payment amount;
wherein in response to determining that the payment amount corresponds to a first purchase amount range included in at least one of the spending definitions in the database payment is made using the at least either a first funding source of the customer account or a second funding source of the customer account that are each associated with the first purchase amount range according to the at least one spending definition.

10. The machine-readable medium of claim 9, wherein at least one of the plurality of spending gate definitions associates the first funding source with the first purchase amount range and the second funding source with the first purchase amount range and a date range, and wherein the payment is made using the first funding source if a current date is outside the date range and the payment is made using the second funding source if the current date is within the date range.

11. The machine-readable medium of claim 9, wherein at least one of the plurality of spending gate definitions associates the first funding source with the first purchase amount range and a minimum balance and the second funding source with the first purchase amount range, and wherein the payment is made using the first funding source if a current balance is above the minimum balance and the payment is made using the second funding source if the current balance is below the minimum balance.

12. The machine-readable medium of claim 9, wherein at least one of the plurality of spending gate definitions associates the first funding source with the first purchase amount range and a maximum balance and the second funding source with the first purchase amount range, and wherein the payment is made using the first funding source if a current balance is below the maximum balance and the payment is made using the second funding source if the current balance is above the maximum balance.

13. The machine-readable medium of claim 9, wherein at least one of the plurality of spending gate definitions associates a plurality of the funding sources, which include the first funding source and the second funding source, with the first purchase amount range and a interest rate condition, and wherein the plurality of machine-readable instructions, when executed by the one or more processors, are adapted to cause the one or more processors to perform the method further comprising:
determining that the first funding source of the plurality of funding sources that are associated with the first purchase amount range complies with the interest rate condition; and
making the payment using the first funding source in response to the first funding source complying with the interest rate condition.

14. The machine-readable medium of claim 9, wherein at least one of the plurality of spending gate definitions associates a plurality of the funding sources, which include the first funding source and the second funding source, with the first purchase amount range and incentive program condition, wherein the plurality of machine-readable instructions, when executed by the one or more processors, are adapted to cause the one or more processors to perform the method further comprising:
determining that the first funding source of the plurality of funding sources that are associated with the first purchase amount range complies with the incentive program condition; and
making the payment using the first funding source in response to the first funding source complying with the incentive program condition.

15. The machine-readable medium of claim 9, wherein at least one of the plurality of spending gate definitions associates the first funding source with the first purchase amount range and the second funding source with the first purchase amount range and a payee, and wherein the payment is made using the first funding source if the payment request is not associated with the payee and the payment is made using the second funding source if the payment request is associated with the payee.

16. The machine-readable medium of claim 9, wherein at least one of the plurality of spending gate definitions associates each of a plurality of the funding sources, which include the first funding source and the second funding source, with the first purchase amount range and a respective payment percentage, and wherein the payment is made using each of the plurality of funding sources associated with the first purchase amount range according to the respective payment percentage.

17. A payment system, comprising:
means for receiving a plurality of spending gate definitions for a customer account, wherein each of the plurality of spending gate definitions associates at least one of a plurality of funding sources of the customer account with a purchase amount range;
means for storing the plurality of spending gate definitions;
means for receiving a payment request for a purchase using the customer account, wherein the payment request includes a payment amount;
means for determining that the payment amount corresponds to either a first purchase amount range or a second purchase amount range included in at least one of the spending definitions;
means for making a payment using a first funding source of the customer account that is associated with the first purchase amount range according to the at least one spending definition; and
means for making a payment using a second funding source of the customer account that is associated with the second purchase amount range according to the at least one spending definition.

18. The system of claim 17, wherein at least one of the plurality of spending gate definitions associates the first funding source with the first purchase amount range and a third funding source with the first purchase amount range and a date range, and wherein the payment is made using the first funding source if a current date is outside the date range and the payment is made using the third funding source if the current date is within the date range.

19. The system of claim 17, wherein at least one of the plurality of spending gate definitions associates the first funding source with the first purchase amount range and a balance and a third funding source with the first purchase amount range, and wherein the payment is made using the first funding source if a current balance is within a first range of the balance and the payment is made using the third funding source if the current balance is outside of the first range of the balance.

20. The system of claim 17, wherein at least one of the plurality of spending gate definitions associates a plurality of the funding sources with the first purchase amount range and a interest rate condition, and wherein system further comprising:
means for determining that the first funding source of the plurality of funding complies with the interest rate condition; and
means for making the payment using the first funding source in response to the first funding source complying with the interest rate condition.
